(19) United States
(12) Patent Application Publication
(10) Pub. No.: US 2013/0334852 A1
(43) Pub. Date: Dec. 19, 2013

(54) Car Seat Strap Tether Apparatus and System

(71) Applicant: Ashely MILEY, Maurertown, VA (US)

(72) Inventor: Ashely MILEY, Maurertown, VA (US)

(21) Appl. No.: 13/495,690

(22) Filed: Jun. 13, 2012

(51) Int. Cl. B60N 2/26

(52) U.S. Cl. 297/250.1

(57) ABSTRACT

Disclosed is a car seat strap tether apparatus including holder provided to an arm member. The arm member may also include a means for removably coupling the apparatus to a car seat. In some embodiments the arm member is selectively positioned to assist the holder in removably holding the car seat straps while the car seat is not being used. In some embodiments, the arm member is flexible and has sufficient memory to support the car seat straps without being deformed. In some embodiments, the holder alone removably holds the car seat straps while the car seat is not in use.

### CROSS-REFERENCE TO RELATED APPLICATIONS

N/A

### FIELD OF INVENTION

The present inventive concept relates generally to the safe, vehicular transport of small children, and more particularly, to an apparatus and system that aid in placing a child in a car seat by removably holding straps of the car seat, thereby providing unobstructed access to the car seat.

### BACKGROUND

The safe, vehicular transportation of small children is of paramount concern in our society. Accordingly, numerous devices to facilitate the safe, vehicular transportation of small children have been provided in the art under the general description of a child restraint system, commonly referred to as a child safety seat, or a car seat.

Generally, car seats are removably installed in automobiles such that a dock unit is secured to the automobile's seat using the automobile's seat belt. A carriage unit may then be releasably docked into the dock unit, thus providing a secure means for the child to be safely restrained in the automobile.

Frequently, carriage units will have their own straps to receive and removably secure a small child thereto. When placing the child into the carriage unit of a conventional car seat however, the car seat's straps may undesirably interfere with or obstruct the access to the car seat itself. Stated differently, gravity may compel the straps to fall and settle in the seat portion of the carriage unit, thereby requiring that they either be removed prior to placing the child in the car seat, or located and removed after the child has already been placed in the car seat. This is frequently undesirable.

For example, an infant may be asleep while being placed in a car seat by a parent or guardian, and may be undesirably awakened by the parent or guardian trying to locate and remove the straps from underneath the infant. Moreover, parents and/or guardians may be in a hurry when attempting to place a child in a car seat, such as in situations involving inclement weather and where placement of the child into the car seat must be done from the exterior of the vehicle. Thus, having to spend extra time locating the car seat's straps after placing the child into the carriage unit of the car seat may be undesirable.

In light of the above, there presently exists a need in the art for a device to restrain the straps of a car seat and aid in placing a small child into the car seat. More specifically, a need exists for a universal restraint device that may be installed on conventional car seats to removably hold the straps so as to provide unobstructed access to the car seat for placing a child therein.

### BRIEF SUMMARY

The present general inventive concept provides a car seat tether apparatus and system to removably couple to a car seat and aid in placing a child in the car seat by holding the car seat's straps so as to provide unobstructed access to the seat of the car seat's carriage member.

According to various embodiments of the present general inventive concept, a car seat strap tether apparatus may include an arm member; a means for removably coupling the arm member to a car seat; and a holder coupled to the arm member, the holder adapted to assist in removably holding a car seat strap so as to aid in the placement of a child into the car seat.

In some embodiments, the arm member is flexible and has sufficient memory to support a car seat strap provided to the car seat.

In some embodiments, a force of at least 0.49 Newtons is required to selectively deform the flexible arm member.

In some embodiments, the means for removably coupling the arm member to a car seat includes a portion of the arm member adapted to receive at least a portion of the car seat on top thereof, such that the holder is positionable proximate the car seat strap.

In some embodiments, the means for removably coupling the arm member to a car seat includes a portion of the arm member adapted to wrap around a structural component of the car seat.

In some embodiments, the means for removably coupling the arm member to a car seat includes a clip coupled to the arm member.

In some embodiments, the holder is substantially flat.

In some embodiments, the apparatus further includes a base member coupling the holder to the arm member.

In some embodiments, the apparatus further includes one or more gussets provided to the base member and the holder.

In some embodiments, the holder is provided substantially perpendicular to the base member.

In some embodiments, the holder is a hook.

In some embodiments, the arm member includes a plurality of sequentially linked units.

In some embodiment, the sequentially linked units are substantially spherical.

In some embodiments, the sequentially linked units are substantially rectangular.

In some embodiments, the arm member is a resiliently bendable wire.

According to various example embodiments of the present general inventive concept, a car seat strap tether apparatus may include a flexible arm member including a plurality of sequentially linked units having sufficient memory to support a strap provided to the car seat; a means for removably coupling the flexible arm member to a car seat; a base member provided to an end of the arm member; a holder provided to the base member to removably hold a car seat strap; and one or more gussets provided to the base member and the holder.

According to various example embodiments of the present general inventive concept, a car seat strap tether system may include a car seat including a seat portion and at least one strap to safely secure a child therein; and a car seat strap tether apparatus with one or more arm members removably coupleable to the conventional car seat proximate the one or more straps; and one or more holders provided to the one or more arm members to assist in removably holding the one or more car seat straps above the seat portion.

In some embodiments, the car seat strap tether apparatus includes a pair of arm members each provided with a respective holder.

Additional aspects and advantages of the present general inventive concept will be set forth in part in the description which follows, and, in part, will be obvious from the description, or may be learned by practice of the present general inventive concept.

### BRIEF DESCRIPTION OF THE FIGURES

The following example embodiments are representative of example techniques and structures designed to carry out the objects of the present general inventive concept, but the present general inventive concept is not limited to these example embodiments. In the accompanying drawings and illustrations, the sizes and relative sizes, shapes, and qualities of lines, entities, and regions may be exaggerated for clarity. A wide variety of additional embodiments will be more readily understood and appreciated through the following detailed description of the example embodiments, with reference to the accompanying drawings in which:

FIG. 1 illustrates an example embodiment of the present general inventive concept removably coupled to a conventional car seat and removably holding the car seat straps;

FIG. 2 illustrates another example embodiment of the present general inventive concept removably coupled to another conventional car seat and removably holding a car seat strap;

FIG. 3A illustrates a perspective view of an example embodiment of the present general inventive concept, showing a holder provided to a flexible arm member that includes a plurality of sequentially linked, substantially rectangular units;

FIG. 3B illustrates another perspective view of the example embodiment holder and arm member of FIG. 3A, wherein a base member is provided to the flexible arm member and holder, and three gussets are provided to the base member and holder;

FIG. 4 illustrates a side view of an example embodiment of the present general inventive concept, wherein a flexible arm member includes a plurality of sequentially linked, substantially spherical units;

FIG. 5 illustrates a side view of another example embodiment of the present general inventive concept, wherein a holder is a hook provided to an arm member;

FIG. 6 illustrates a side view of yet another example embodiment of the present general inventive concept, wherein a flexible arm member is a resiliently bendable wire; and

FIG. 7 illustrates yet another example embodiment of the present general inventive concept, wherein an arm member provided with a clip to removably couple it to the car seat, proximate a car seat strap.

### DETAILED DESCRIPTION

Reference will now be made to various example embodiments of the present general inventive concept, examples of which are illustrated in the accompanying drawings and illustrations. The example embodiments are described herein in order to explain the present general inventive concept by referring to the figures. The following detailed description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art.

In accordance with various embodiments of the present general inventive concept, a car seat strap tether apparatus includes a holder provided to an arm member. The arm member may be adapted to be removably coupled to a conventional car seat. The arm member may be flexible and may have sufficient memory to substantially retain its shape while supporting a car seat strap.

Hereinafter “memory” is used to refer to a material or a structural relationship that causes the arm member to be selectively and/or resiliently deformable such that it substantially maintains its shape when certain forces are applied thereto. For instance, wires may have memory by virtue of their material being resiliently bendable. Additionally, structures that include sequentially linked units may have memory by virtue of friction or interference fit between contiguous units, as in U.S. Pat. No. 7,891,615, the contents of which are incorporated by reference herein. One of skill in the art will recognize that a number of known or later developed materials and/or structural relationships may be adapted to function as a flexible arm member without departing from the scope or spirit of the present general inventive concept.

Various embodiments of the present general inventive concept may include a flexible arm member having sufficient memory to support a car seat strap and an optionally accompanying buckle. For example, in order to hold a 0.05 kilogram car seat strap and accompanying buckle, the arm member has sufficient memory to withstand a force of at least 0.49 Newtons without being deformed. Stated differently, a force greater than 0.05 kilograms multiplied by gravitational acceleration (9.8 m/s2) (also referred to as gravitational force) is necessary to reposition the example embodiment arm member. It will be noted that use of the term “sufficient memory” hereafter will refer to memory that substantially precludes deformation unless a force is applied that is greater than the gravitational force of a car seat strap and optionally accompanying buckle. Stated differently, “sufficient memory” refers to the ability of the arm member to substantially maintain its shape while supporting an elevated car seat strap and optionally accompanying buckle. In various embodiments, the arm member has sufficient memory to hold a car seat strap, but not so much memory so as to substantially prevent selective deformation and/or repositioning by individuals of average strength. Hereinafter, the term “flexible” will refer to a material or structural relationship that permits individuals of average strength to selectively reshape the arm member.

In various embodiments, the arm member may be adapted to be removably coupled to a conventional car seat. In one example embodiment, the arm member's flexibility and memory permits it to be selectively positioned with respect to the car seat to maintain its position. In one example embodiment, the arm member wraps around a structural component of the car seat, thereby facilitating a removable coupling. In another example embodiment, the arm member is adapted to removably clip onto a component of the car seat, proximate a car seat strap. One of skill in the art will recognize that there are numerous ways in which the arm member may be removably coupled to a car seat, including, but not limited to, Velcro®, snaps, suction cups, and/or adhesive, without departing from the present general inventive concept.

Various embodiments of the present general inventive concept may include a holder to assist in receiving and removably holding a car seat strap. The holder may rely on its shape and gravity to removably restrain the car seat strap. In one example embodiment, the holder is a hook from which a car seat strap may hang. In another example embodiment, the holder is a panel member provided to the arm member such that the strap is held by the panel member. In yet another example embodiment, the arm member is angularly extended and shaped to provide a holder on which the strap may hang. It will be noted that in various embodiments the holder and arm member cooperate to removably hold a car seat strap above the seat portion of a car seat, and in other embodiments the holder alone removably holds the car seat strap.

It can be determined from the foregoing discussion that a car seat strap tether apparatus and system, according to various example embodiments of the present general inventive concept, has applicability to aid in placing a child in a car seat by restraining the car seat's straps so as to provide unobstructed access to the seat of the car seat's carriage member.

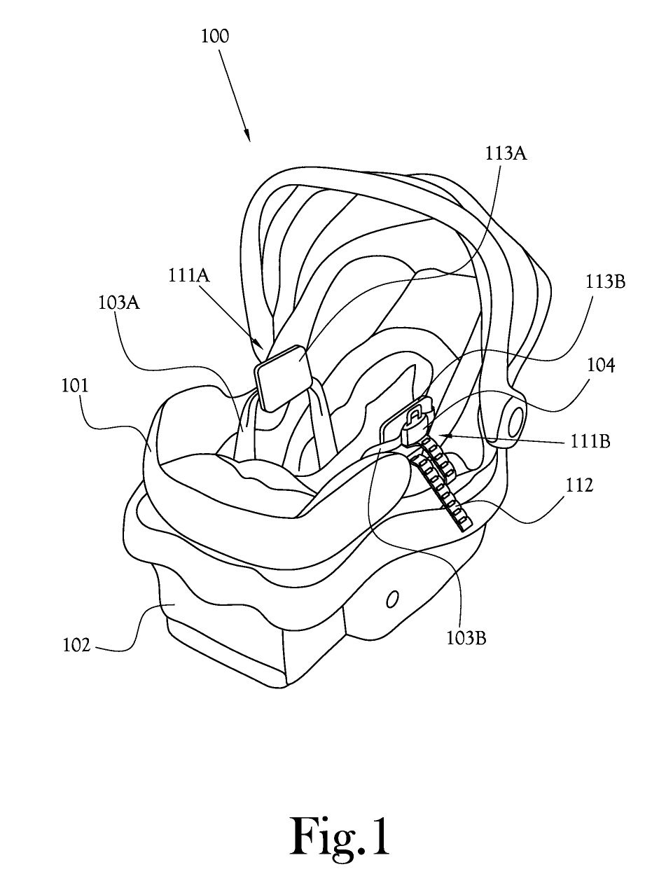

FIG. 1 illustrates an example embodiment conventional car seat 100. A carriage unit 101 is docked into a dock unit 102. Straps 103A and 103B, as well as an accompanying buckle mechanism 104 are provided to the carriage unit 101 to adjustably secure a child therein. It will be noted that use of the phrase “car seat strap” hereinafter refers to both car seat straps and/or belts with and/or without accompanying buckle mechanisms. Two example embodiment car seat strap tether apparatuses are shown at 111A and 111B. As illustrated, a flexible arm member 112 is provided to a holder 113B (an unillustrated flexible arm member is also provided with holder 113A). The flexible arm member 112 is removably coupled to the conventional car seat 100 by wrapping around a structural component of the conventional car seat 100, proximate the car seat strap 103B. A holder 113B, in combination with the flexible arm member 112, removably holds the car seat strap and prevents it from falling into the seat portion of the carriage unit 101 of the conventional car seat 100.

The flexible arm member 112 in the FIG. 1 has sufficient memory to support the elevated car seat strap 103B above the carriage unit 101. Stated differently, a force of greater than the gravitational force of the car seat strap 103B is required to deform the flexible arm member 112. Additionally, the memory of the flexible arm member 112 also facilitates its removable coupling to the structural component in the illustrated example embodiment.

Once the car seat straps 103A and 103B have been removably restrained by the holders and flexible arm members, as in FIG. 1, a child may be placed into the carriage unit 101 of the conventional car seat 100. Access to the seat portion of the carriage unit 100 is unobstructed due to the car seat straps 103A and 103B being held above the seat portion and out of the way by the example embodiment car seat strap tether apparatuses 111A and 111B. After positioning the child in the car seat 100, the car seat straps 103A and 103B may be removed from the holders 113A and 113B, as well as the flexible arm members 112, to secure the child.

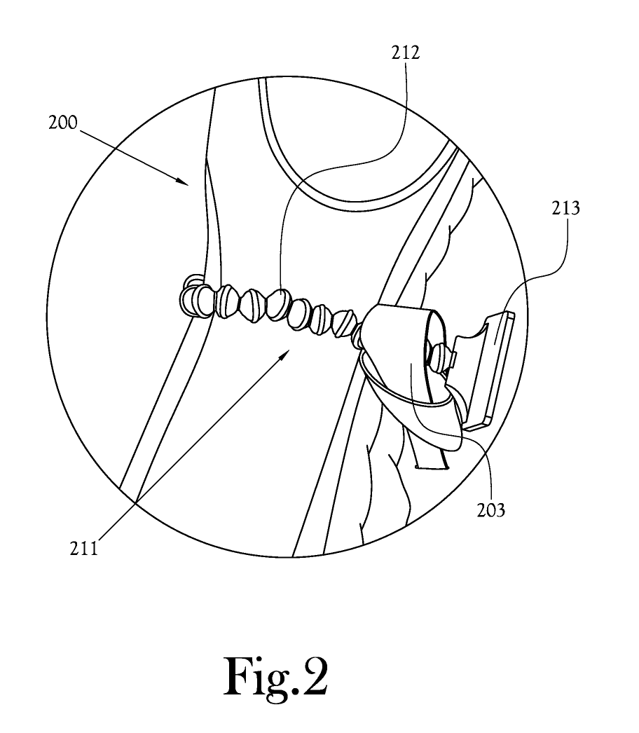

FIG. 2 illustrates a top-down view of another example embodiment of the present general inventive concept removably coupled to another conventional car seat 200 and removably restraining a car seat strap 203. Similar to the example embodiment of FIG. 1, a car seat strap tether apparatus 211 includes a flexible arm member 212 provided with a holder 213. The flexible arm member has been removably coupled to the car seat 200 by wrapping around a structural component thereof, proximate the car seat strap 203.

The present general inventive concept is not limited to the manner in which the flexible arm member is removably coupled to a conventional car seat. On the contrary, the flexible arm member 212 in the illustrated example embodiment may wrap around a different structural component of the conventional car seat 200. In other embodiments, parts of the flexible arm member may be removably coupleable to other parts of the flexible arm member, thereby facilitating the removable coupling of the flexible arm member to the conventional car seat and enabling the present general inventive concept to be properly and selectively positioned to removably restrain the car seat straps.

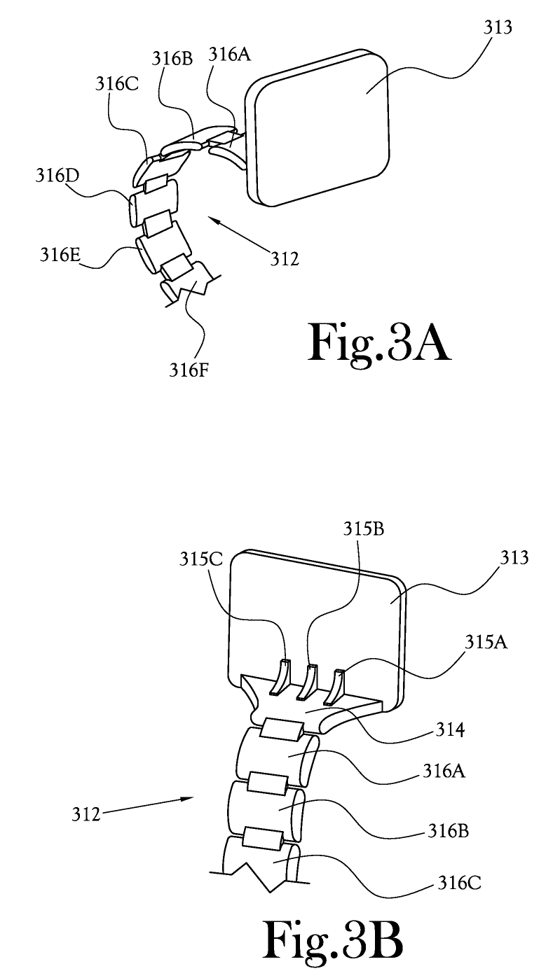

FIG. 3A illustrates a perspective view of an example embodiment arm member 312 and holder 313. As illustrated, the substantially flat holder 313 is provided to the flexible arm member 312 such that a substantially 90 degree angle is formed between the holder 313 and the proximal end of the arm member 312. One of skill in the art will recognize that the present general inventive concept is not limited to a holder of any particular shape or dimension.

FIG. 3B illustrates another perspective view of the example embodiment arm member 312 and holder 313 from of FIG. 3A, further including and illustrating a base member 314 provided to the proximal end of the arm member 312 and holder 313, in addition to three gussets 315A-C provided to the base member 314 and holder 313. Similar to FIG. 3A, the substantially flat holder 313 and base member 314 may form a substantially 90 degree angle therebetween. One of skill in the art will recognize that the holder may be provided at numerous angles to the arm member and base member to removably restrain the car seat strap.

In various embodiments, a base member 314 is interposed between the holder 313 and the arm member 312, as in FIG. 3B. In some embodiments, the base member is the proximate-most sequentially linked unit 316A of the arm member 312. In other embodiments, the base member is a not a link, but is nonetheless provided to a portion of the arm member thereby coupling the holder to the arm member. Gussets 315A-C may be provided to the base member 314 and holder 313 to reinforce the coupling therebetween, as in the illustrated embodiment. In various embodiments, one or more gussets facilitate the selective, angular adjustment of the holder, relative to the base member.

FIGS. 3A and 3B illustrate an example embodiment arm member 312 that includes a plurality of sequentially linked, substantially rectangular units 316a-f. In the illustrated example embodiment, the memory of the arm member 312 is derived from the coupling relationship between each of the linked units 316a-f. Further, each linked unit is independently, selectively positionable relative to contiguous units, thereby providing flexibility to the arm member 312.

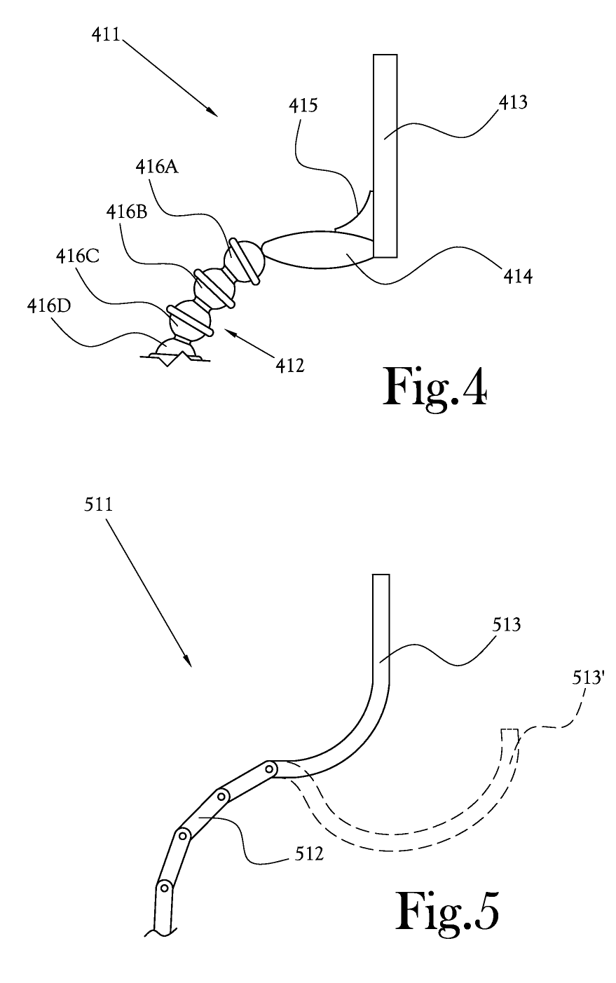

FIG. 4 illustrates a side view of an example embodiment car seat strap tether apparatus 411, wherein a flexible arm member 412 includes a plurality of sequentially linked spherical units 416A-D coupled to a holder 413. In the present example embodiment, the flexible arm member's memory is derived from the interference fit of the contiguous spherical units 416A-D. A base member 414 is provided to both the holder 413 and proximal end of the arm member 412. At least one gusset 415 is provided to both the holder 413 and base member 414.

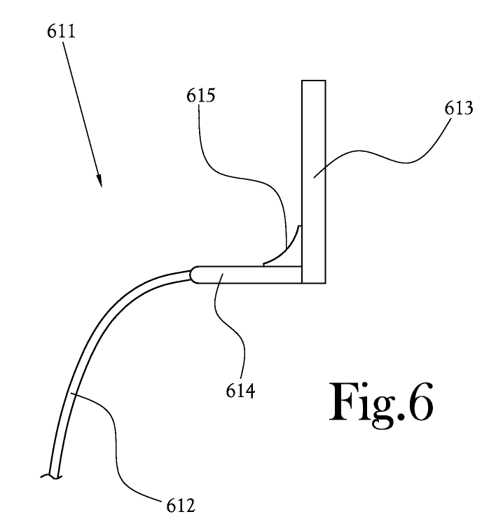

FIG. 5 illustrates another example embodiment car seat strap tether apparatus 511 that includes a holder 513 or 513′ provided to a flexible arm member 512. In the illustrated embodiment, the holder 513 or 513′ is generally shaped as a hook. Thus, in the illustrated embodiment, the holder 513 or 513′ alone removably restrains the car seat strap, as opposed to the embodiments in which the holder and flexible arm member operate in concert to removably restrain the car seat strap.

FIG. 6 illustrates yet another example embodiment car seat strap tether apparatus 611 that includes a base member 614 provided to a flexible arm member 612 and a holder 613, as well as at least one gusset 615 provided to the base member 614 and holder 613. In the illustrated embodiment, the flexible arm member 612 is a resiliently bendable wire, thereby providing memory and flexibility to the arm member 612.

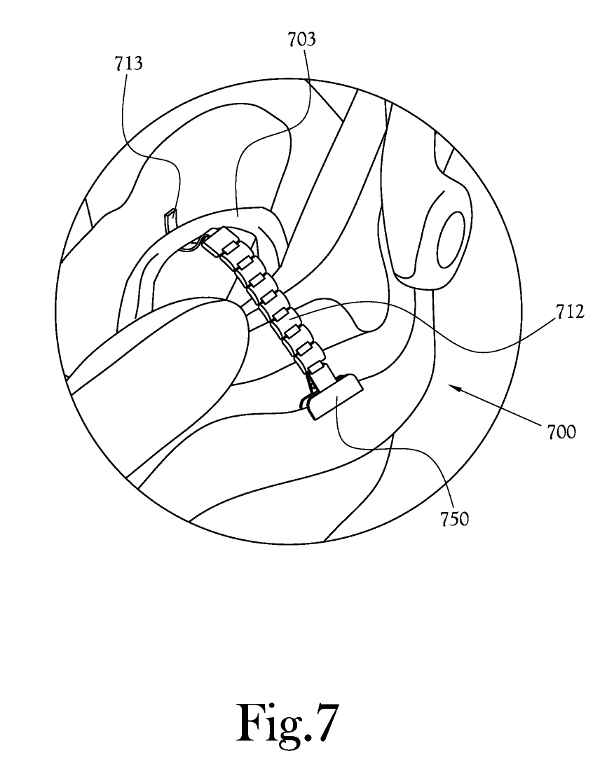

FIG. 7 illustrates another example embodiment arm member provided with a holder and removably coupled to the car seat by virtue of a clip. As illustrated, the arm member 712 is provided with a holder 713 to receive and hold a car seat strap 703. A clip 750 is provided to the arm member 712 on the end distal the holder 713, to removably couple the arm member to the car seat 700 proximate the car seat strap 703. One of skill in the art will recognize that in embodiments where the arm member is removably coupled to the car seat by a means other than wrapping around a structural component of the car seat, as currently illustrated, that the arm member need not be flexible. Stated differently, in one example embodiment, the arm member is a substantially rigid member and is removably coupled to the car seat by a clip.

In another unillustrated, example embodiment of the present general inventive concept, two holders are provided to each opposing end of a single, flexible arm member. One or more components of a car seat may be positioned on top of the arm member, leaving both ends and holders exposed and selectively positionable proximate the one or more car seat straps to removably hold the one or more car seat straps.

Various example embodiments of the present general inventive concept may also include a car seat strap tether system. In one unillustrated embodiments, a car seat strap tether system includes a car seat having a seat portion and at least one strap to safely secure a child therein. The system further includes a car seat strap tether apparatus having an arm member coupled to the car seat proximate the one or more straps, and a holder provided to the arm member to assist in removably holding the one or more straps above the seat portion of the car seat. In another embodiment, the system includes two arm members coupled to the car seat, with a holder provided to both arm members.

It will be understood from the foregoing discussion that a car seat tether apparatus and system has applicability in aiding in the placement of a child into a car seat by removably holding the car seat straps above the seat portion of the car seat. Generally, the car seat strap tether apparatus includes an arm member with a means of removably coupling to a car seat. A holder may be provided to the arm member to aid in removably holding a car seat strap.

Numerous variations, modifications, and additional embodiments are possible, and accordingly, all such variations, modifications, and embodiments are to be regarded as being within the spirit and scope of the present general inventive concept. For example, regardless of the content of any portion of this application, unless clearly specified to the contrary, there is no requirement for the inclusion in any claim herein or of any application claiming priority hereto of any particular described or illustrated activity or element, any particular sequence of such activities, or any particular interrelationship of such elements. Moreover, any activity can be repeated, any activity can be performed by multiple entities, and/or any element can be duplicated.

While the present general inventive concept has been illustrated by description of several example embodiments, it is not the intention of the applicant to restrict or in any way limit the scope of the inventive concept to such descriptions and illustrations. Instead, the descriptions, drawings, and claims herein are to be regarded as illustrative in nature, and not as restrictive, and additional embodiments will readily appear to those skilled in the art upon reading the above description and drawings.

1. A car seat strap tether apparatus comprising:
an arm member;
a means for removably coupling the arm member to a car seat; and
a holder coupled to the arm member, the holder adapted to assist in removably holding a car seat strap so as to aid in the placement of a child into the car seat.

2. The apparatus of claim 1, wherein the arm member is flexible and has sufficient memory to support a car seat strap provided to the car seat.

3. The apparatus of claim 2, wherein a force of at least 0.49 Newtons is required to selectively deform the flexible arm member.

4. The apparatus of claim 2, wherein the means for removably coupling the arm member to a car seat comprises a portion of the arm member adapted to receive at least a portion of the car seat on top thereof, such that the holder is positionable proximate the car seat strap.

5. The apparatus of claim 1, wherein the means for removably coupling the arm member to a car seat comprises a portion of the arm member adapted to wrap around a structural component of the car seat.

6. The apparatus of claim 1, wherein the means for removably coupling the arm member to a car seat comprises a clip coupled to the arm member.

7. The apparatus of claim 1, wherein the holder is substantially flat.

8. The apparatus of claim 1, further comprising a base member coupling the holder to the arm member.

9. The apparatus of claim 8, further comprising one or more gussets provided to the base member and the holder.

10. The apparatus of claim 8, wherein the holder is provided substantially perpendicular to the base member.

11. The apparatus of claim 1, wherein the holder is a hook.

12. The apparatus of claim 1, wherein the arm member includes a plurality of sequentially linked units.

13. The apparatus of claim 12, wherein the sequentially linked units are substantially spherical.

14. The apparatus of claim 12, wherein the sequentially linked units are substantially rectangular.

15. The apparatus of claim 1, wherein the arm member is a resiliently bendable wire.

16. A car seat strap tether apparatus comprising:
a flexible arm member including a plurality of sequentially linked units, the flexible arm member having sufficient memory to support a car seat strap;
a means for removably coupling the flexible arm member to a car seat;
a base member provided to an end of the arm member;
a holder provided to the base member to removably hold a car seat strap; and
one or more gussets provided to the base member and the holder.

17. A car seat strap tether system comprising:
a car seat including a seat portion and at least one strap to safely secure a child therein; and
a car seat strap tether apparatus comprising:
one or more arm members coupled to the conventional car seat proximate the one or more straps; and
one or more holders provided to the one or more arm members to assist in removably holding the one or more car seat straps above the seat portion.

18. The car seat strap tether system of claim 17, wherein the car seat strap tether apparatus comprises a pair of arm members each provided with a respective holder.
